(19) United States
(12) Patent Application Publication
(10) Pub. No.: US 2011/0303069 A1
(43) Pub. Date: Dec. 15, 2011

(54) DETACHABLE PUNCH MOLD

(75) Inventor: SUI-JING CAI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/904,381

(22) Filed: Oct. 14, 2010

(30) Foreign Application Priority Data
Jun. 11, 2010 (CN) 201010198884.8

(51) Int. Cl. B26F 1/14

(52) U.S. Cl. 83/698.91

(57) ABSTRACT

A detachable punch mold includes a mold base, a punch detachably attached to the mold base, and a pair of latch members attached to the mold base. Each latch member has a head movable between a first position to prevent the punch from moving away from the mold base along a first direction and a second position to release the punch.

### BACKGROUND

1. Technical Field

The present disclosure relates to a detachable punch mold.

2. Description of Related Art

Referring to FIG. 4, a typical punch mold, according to the prior art, includes a cylindrical main body and a punch integrally protruding from a top portion of the cylindrical main body. The punch is used to cut holes or form indentations in sheet metal. The punch is prone to wear and tear. However, the conventional punch mold is integrally formed and not detachable. Once the punch wears out or breaks, the whole punch mold has to be discarded, which is wasteful. Furthermore, the typical integrally formed punch mold is not easily fabricated.

What is needed, therefore, is a detachable punch mold that overcomes the above-described shortcomings.

### BRIEF DESCRIPTION OF THE DRAWINGS

FIG. 1 is an exploded view of an embodiment of a detachable punch mold according to the present disclosure.

FIG. 2 is a cross sectional view of a latch member in FIG. 1.

FIG. 3 is an assembled view of FIG. 1.

FIG. 4 illustrates a typical punch mold according to related art.

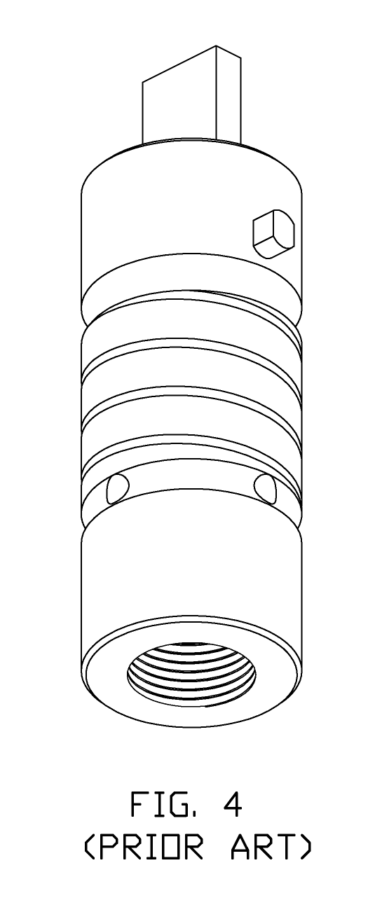

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

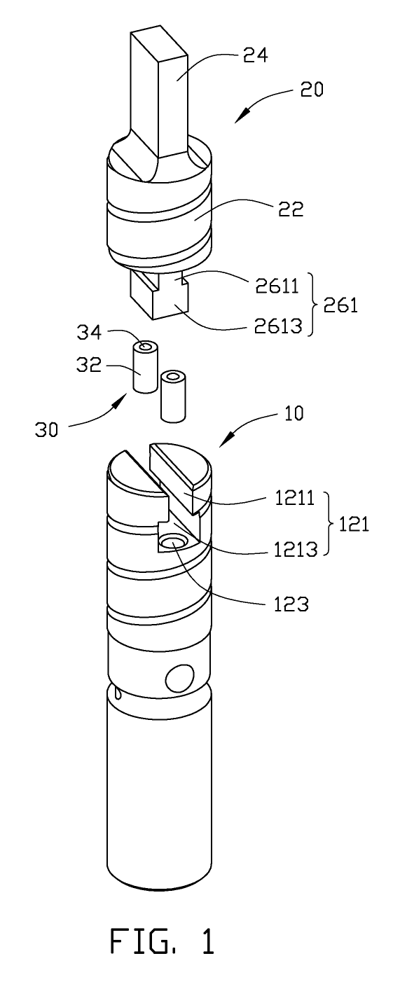

Referring to FIG. 1, an embodiment of a detachable punch mold includes a mold base 10, a punch 20, and a pair of latch members 30. A flange of the punch 20 can be used to cut sheet metal.

The mold base 10 has a cylindrical shape. A mounting groove 121 is defined in a top portion of the mold base 10. The mounting groove 121 has a narrower portion 1211 and a wider portion 1213. A pair of cylindrical cavities 123 is defined in the mold base 10 at the bottom of the mounting groove 121.

The punch 20 includes a cylindrical support 22, a head 24 extending from a top of the cylindrical support 22, and a mounting block 261 extending from a base of the cylindrical support 22. The mounting block 261 includes a neck portion 2611 and an engaging portion 2613 wider than the neck portion 2611. A width of the neck portion 2611 is substantially equal to that of the narrow portion 1211 of the mounting groove 121 of the mold base 10. A width of the engaging portion 2613 is substantially equal to that of the wide portion 1213 of mounting groove 121 of the mold base 10. A length of a rectangular base of the mounting block 261 is less than a diameter of the mold base 10.

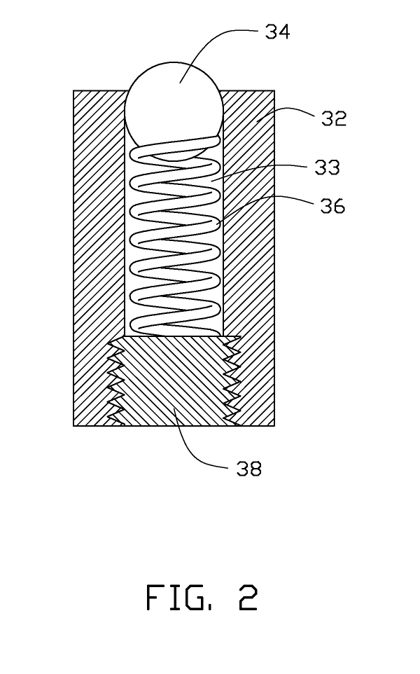

Referring to FIG. 2, the latch member 30 includes a cylindrical shell 32 with a cavity 33 defined therein, a metallic ball 34 mounted at a top portion of the shell 32, a spring 36 mounted in the cavity 33 of the shell 32, and a height-adjustable screw 38 mounted at a base portion of the shell 32. The spring 36 is located between the metallic ball 34 and the height-adjustable screw 38. A diameter of a top entrance of the cavity 33 of the shell 32 is less than that of the metallic ball 34. A diameter of a bottom entrance of the cavity 33 of the shell 32 is not less than the diameter of the metallic ball 34. Thus, the metallic ball 34 can enter or exit from the cavity 33 through the bottom entrance of the shell 32, but cannot enter or exit through the top entrance of the shell 32. The metallic ball 34 can move downwards after being depressed. The spring 36 can biases the metallic ball 34 back to its natural position. Since a height of the screw 38 is adjustable, a bias force of the spring 36 is adjustable.

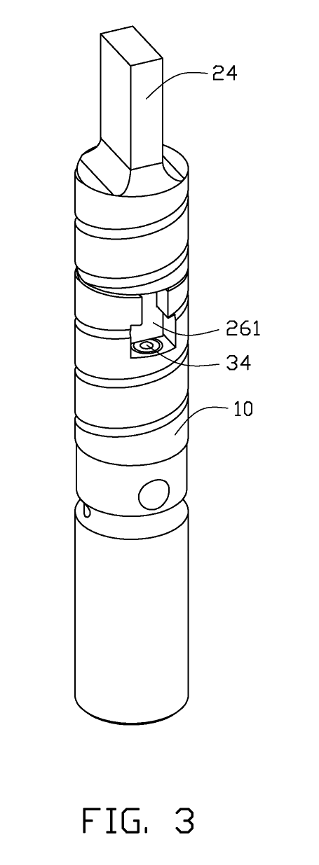

Referring to FIG. 3, in assembly, the pair of latch members 30 are mounted in the cavities 123 of the mold base 10. A top surface of the shell 32 of each of the latch members 30 locates at a same horizontal plane as the bottom surface of the mounting groove 121 of the mold base 10. The metallic balls 34 of the latch members 30 protrude upwardly from the bottom surface of the mounting groove 121. One of the metallic balls 34 is depressed for allowing the mounting block 261 of the punch 20 sliding into the mounting groove 121 of the mold base 10. After the mounting block 261 of the punch 20 is slid into the mounting groove 121 along a horizontal direction, the neck portion 2611 of the mounting block 261 is engaged in the narrower portion 1211 of the mounting groove 121, the engaging portion 2613 is engaged in the wider portion 1213 of the mounting groove 121, and the engaging portion 2613 of the punch 20 is sandwiched between the metallic balls 34 of the latch members 30. Thus, the punch 20 is secured to the mold base 10. The bottom surface of the cylindrical support 22 of the punch 20 abuts the mold base 10.

If the edges of the punch 20 becomes abraded, the metallic ball 34 can be depressed, and the punch 20 can then be slid away from the mounting groove 121 of the mold base 10. Therefore, it is easy to install and replace a punch.

In one embodiment, the appearance and function of the punch mold of the present disclosure is unchanged relative to the conventional punch mold. Furthermore, the punch mold of the present disclosure is made of detachable parts. Each of the parts can be easily formed, and each of the parts can be used in other molds. The punch mold can be widely used in currently used equipment and provide cost-savings.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

What is claimed is:

1. A detachable punch mold comprising:
a mold base,
a punch detachably attached to the mold base; and
a pair of latch members attached to the mold base, the pair of latch members each having a head movable between a first position and a second position;
wherein in the first position, the head is capable of preventing the punch from moving away from the mold base along a first direction; and in the second position, the punch is capable of sliding across the head along the first position to disengage from the mold base.

2. The detachable punch mold of claim 1, wherein a mounting groove is defined in the mold base, the punch comprises a mounting block, and the mounting block is engaged in the mounting groove to prevent the punch from moving away from the mold base along a second direction, that is perpendicular to the first direction.

3. The detachable punch mold of claim 2, wherein the mounting groove comprises a narrower portion and a wider portion, and the mounting block comprises a neck portion engaged in the narrower portion and an engaging portion engaged in the wider portion.

4. The detachable punch mold of claim 3, wherein the mold base has a cylindrical shape, and a length of a rectangular base of the engaging portion is less than a diameter of the mold base.

5. The detachable punch mold of claim 2, wherein a pair of cavities are defined in the mold base at a bottom of the mounting groove, and the pair of latch members are mounted in the pair of cavities.

6. The detachable punch mold of claim 1, wherein the pair of latch members each comprises a cylindrical shell with a cavity defined therein and a spring mounted in the cavity, and the spring abuts and biases the head towards its original position.

7. The detachable punch mold of claim 6, wherein the head is a movable ball attached to a top portion of the cylindrical shell and is supported by the spring.

8. The detachable punch mold of claim 7, wherein the pair of latch members each comprises a height-adjustable screw attached at a base portion of the cavity, and the spring is located between the movable ball and the height-adjustable screw.

9. The detachable punch mold of claim 8, wherein a diameter of a top entrance of the cavity is less than that of the movable ball, and a diameter of a bottom entrance of the cavity is greater than that of the movable ball.

10. A detachable punch mold comprising:
a mold base with a mounting groove and a pair of cavities defined therein;
a punch comprising a mounting block engaged in the mounting groove to prevent the punch from moving away from the mold base along a first direction; and
a pair of latch members, partially received in the pair of cavities, located at opposite sides of the mounting block to prevent the punch from moving away from the mold base along a second direction perpendicular to the first direction.

11. The detachable punch mold of claim 10, wherein the mounting groove comprises a narrower portion and a wider portion connected to the narrower portion, the mounting block comprises a neck portion engaged in the narrower portion and an engaging portion engaged in the wider portion.

12. The detachable punch mold of claim 11, wherein the mold base has a cylindrical shape, and a length of a rectangular base of the engaging portion is less than a diameter of the mold base.

13. The detachable punch mold of claim 10, wherein the pair of latch members each comprises a hollow shell, a spring mounted in the hollow shell, a movable member attached at a top portion of the hollow shell.

14. The detachable punch mold of claim 13, wherein the pair of latch members each comprises a height-adjustable screw attached at a base portion of the hollow shell, and the spring is located between the movable member and the height-adjustable screw.

15. The detachable punch mold of claim 14, wherein the movable member is a ball partially protruding from a top surface of the hollow shell.

16. The detachable punch mold of claim 15, wherein a diameter of a top entrance of each of the pair of cavities is less than that of the ball, a diameter of a bottom entrance of each of the pair of cavities greater than that of the movable ball.

17. The detachable punch mold of claim 10, wherein the punch comprises a support and a head extending from a top portion of the support, the mounting block extends from a bottom portion of the support.

18. The detachable punch mold of claim 17, wherein the support abuts on a top surface of the mold base.
